(19) United States
(12) Patent Application Publication
(10) Pub. No.: US 2012/0156631 A1
(43) Pub. Date: Jun. 21, 2012

(54) DENTAL PROSTHESIS FOR BOVINE ANIMALS WITH FULLY OR PARTIALLY WORN DOWN TEETH

(76) Inventor: Osvaldo Rodolfo Errobidart, Provencia de Buenos Aires (AR)

(21) Appl. No.: 13/391,854

(22) PCT Filed: Aug. 24, 2010
(86) PCT No.: PCT/CL2010/000031

§ 371 Date: Feb. 23, 2012

(30) Foreign Application Priority Data
Aug. 24, 2009 (AR) 20090103245

(51) Int. Cl. A61D 5/00

(52) U.S. Cl. 433/1

(57) ABSTRACT

The invention relates to a standard dental prosthesis for bovine animals with fully or partially worn down teeth. For bovine animals with partially worn down teeth, the prosthesis is a laminar plate consisting of a rigid material, bent forwards (1), with an upward fold having a sawn edge along its front curve (27) that is connected to a lower laminate of the same shape and size, from which a tongue (8) projects downwards into the central front zone, at the end of which two small laminates (10) are folded, and in the rear part, a tongue (12) projects behind, and divides into two (13), thereby creating a fold towards the front (14) and encompassing two wires in the transverse direction (16), the ends of which are housed in the front laminates (10). For bovine animals with fully worn down teeth, the laminar plates (1) and (3) have a downwardly inclined fold along the entire front curve (37) thereof.

### TECHNICAL FIELD

This invention refers to the standard dental prosthesis for bovine animals that brings a solution to the worn down teeth in each and all grades thereof, with mechanical retention in the waist of the lower premaxilla.

### PRIOR ART

See Argentine Patents Nos. 020100491 and 050100253 for the art state.

### Advantages as Regards Prior Art

a) The sawn edge (27) allows an easy and quick grass cutting, while at the same time it produces less tension of the device over the premaxilla increasing the animal comfort.

b) The upper nonslip zone (5) prevents the grass from slipping when being pulled up upon being pressed by the upper jaw, and also prevents the prosthesis from being projected forwards at the same time.

c) The extension downwards the front close (8) allows the arms closing in a smaller diameter and further down, where the bone of the premaxilla is stronger and more solid getting away from the lateral wings of the premaxilla (21) which are highly fragile and breaks when a retention arm works in that zone. In FIG. 24, we can appreciate that the close support (8) by being longer it may be housed under the dead angle of the premaxilla (20) preventing the prosthesis from moving in a sense (32) that causes the rear part or the front zone moving upwards, as shown in (33).

d) The lower zone of the lower laminar plate (3) is fully flat because the rear fold that fits behind the incisors has been suppressed; this is so because the efficiency of the arms allows the widening of the standardization and eliminates the pivot produced in the prosthesis caused by this fold which also produced a strong wear down behind the incisors and, in some cases it pushed them forwards when they were loose thereby causing the loss of some pieces.

e) Between the premaxilla (18) and the lower jaw (24) there are different natural inclination angles that are produced by different grades of wearing down of the incisors (19) as shown in FIG. 19, that if they are not properly regulated in the prosthesis of the prior art, a free space (28) appears in the right side, as shown in FIG. 20, between the retainer and the waist of the premaxilla, causing a pivot of the prosthesis in the sense (29) and goes out in the sense (30). The premaxillas also differ in its length, as shown in FIG. 21, thereby the prosthesis of the prior art should be modified by either shortening or lengthening the prosthesis with a tool (31) in order to get adjusted; these operations are complicated and in the prosthesis of the present invention this operation is automatically made by only adjusting the retainers (16).

f) The retainers which are made of fibers may be used in this prosthesis without any modification of the device.

g) The shape for the animals' prosthesis with fully worn down teeth allows the recovery of animals that had no further solution before.

### DESCRIPTION OF FIGURES

FIGS. 1, 2, 3, 4 and 5: are views of the dental prosthesis for bovines with partially worn down teeth as from different positions.

FIGS. 6, 7, 8, 9 and 10 are views of the same prosthesis placed on a premaxilla of the bovine animal, with different positions.

FIGS. 11, 12, 13, 14 and 15 are views of the dental prosthesis for bovine animals with fully worn down teeth as from different positions.

FIGS. 16, 17 and 18 are views of the same dental prosthesis placed on a premaxilla of the bovine animal with fully worn down teeth as from different positions.

FIG. 19 shows the different angles of the premaxilla.

FIGS. 20 and 21 show the different problems of the prior art.

FIG. 22 shows how the present invention solves said problems.

FIG. 23 shows the deformities in the upper jaw.

FIG. 24 shows both shapes of the dental prosthesis.

FIG. 25 shows the dental prosthesis taken apart.

FIG. 26 shows the retainers made of flexible fiber.

### EMBODIMENT OF THE INVENTION

The standard dental prosthesis for bovine animals in its different shapes may be made of metal or other rigid materials.

### Production

The prosthesis may be made of stainless steel using the split and stamping technique with matrixes installed in a metallurgical swinging arm, then pieces are joined by pressing the wire helmet, and through ring staples, screws and welding in the case of the upper and lower laminar plates.

### Disclosure of the Invention

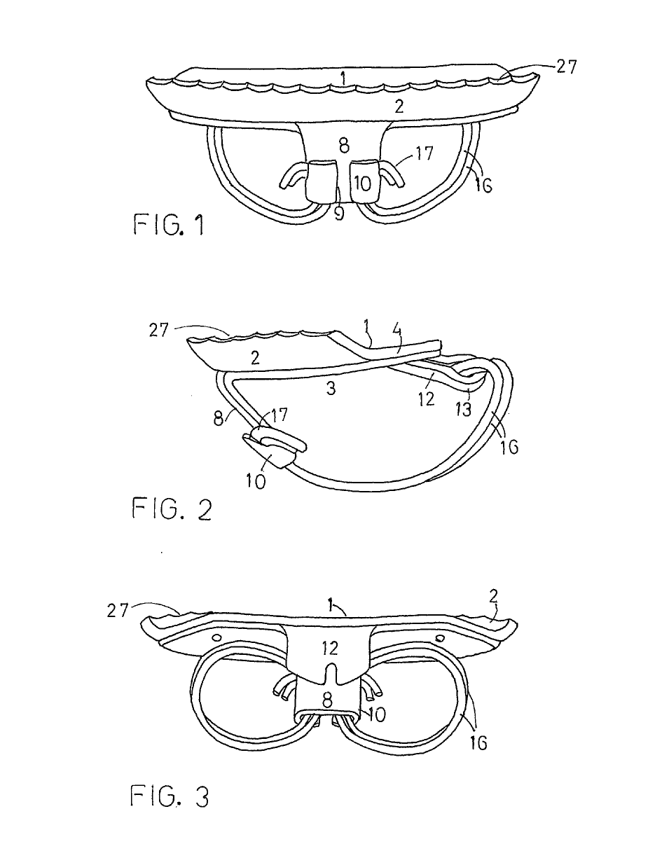

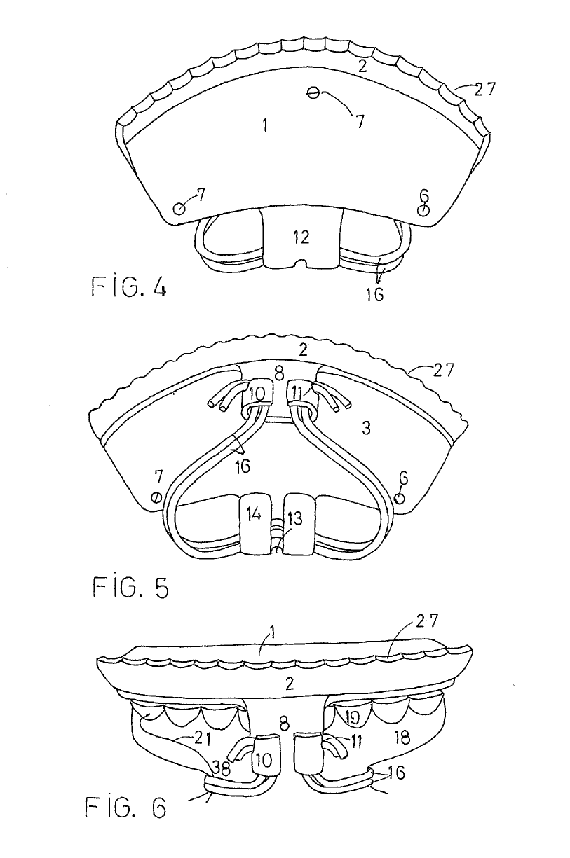

First, the standard dental prosthesis for bovine animals with partially worn down teeth is described; as shown from different angles in FIGS. 1, 2, 3, 4 and 5 where the upper laminar plate (1) made of rigid and stainless material is found in a horizontal position, curved forwards with slightly convergent side backwards (4), with a fold upwards and forwards (2) with the sawn upper edge (27) in the entire front curvature thereof, with a nonslip surface in the upper zone (5), with drillings (6) to house screws, ring staples, etc. (7), mounted and fixed over the lower laminar body (3) of the same shape and size as the one that projects in the front-central zone, a tongue projects downwards behind (8) in which end two smaller tongues are folded (10) over the front face from each side, facing themselves with the free end thereof (9), with a pocket (11) in the upper part of each fold (10). From the rear and central zone of the lower laminar plate (3) a tongue is projected behind with a slight inclination downwards, which is referred to as retainers (12), whose end divides into two (13) and produces a fold over itself forwards where it is fixed in the ends thereof by welding, screws, etc. (14), encompassing two wires of stainless steel of the aisi 316 soft type, in the transverse direction, with a diameter of approximately 1.75 mm. (16), and after a small curve of retention (15), a pair goes out through each side and enters into through the lower part of the close laminates (10), going out through each pocket (11), where they are fixed by a fold downwards (17).

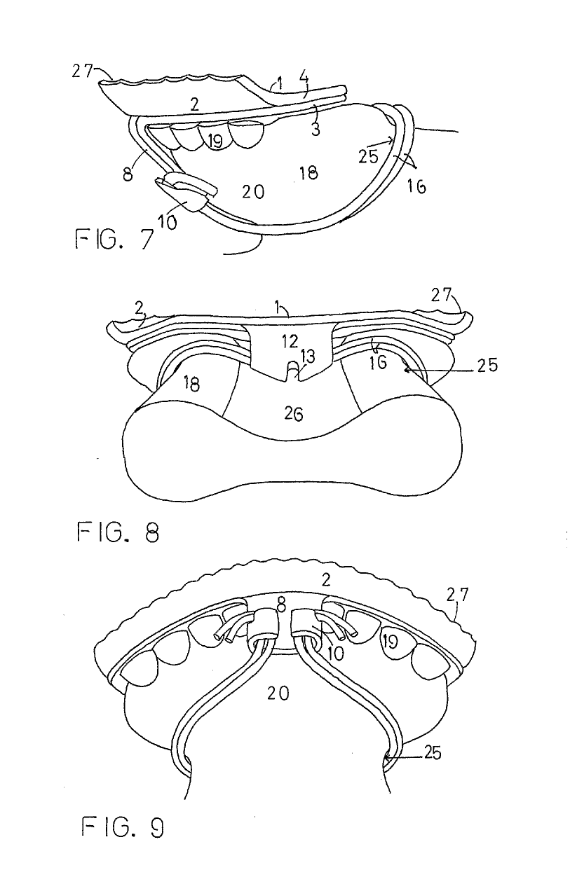

FIGS. 6, 7, 8, 9 and 10 show the prosthesis placed on a premaxilla (18) with primary worn down incisor teeth (19), being possible to appreciate how the prosthesis covers the group of premaxilla and the teeth, stopping the dental worn down and increasing the teeth length, FIG. 6 point (2). In (8) it can be seen how the close support is projected into the mentalis zone of the premaxilla (20), where the bone forms a highly retained dead angle as shown in FIG. 7. In FIG. 6 point (21) the bone of the premaxilla in the form of a wing (21) is shown, very weak with much soft tissue surrounding thereto; when the retainers work in this zone, the bone is broken in the form of a wing (21) and the prosthesis goes out, however by reaching the lower waist of the premaxilla (38) where the bone is solid, the maximum retention is obtained.

In FIG. 8 the prosthesis mounted on the premaxilla (18) is shown as from behind, where the point (12) shows how the retainers support goes down over the lingual channel (26). This retainers support disposed in the centre with a strong structure allows the automatic adjustment of the retainers (16) to the waist of the premaxilla independently of the inclination grade of the premaxilla with respect to the jaw, to the worn down incisors, to the waist diameter, just tightening to the front close (10).

FIG. 9 shows, from downwards, the rear waist of the premaxilla (25) where the retainers are fixed (16) that by being double bring the following advantages:

a) Support the fatigue of millions of annual cuttings

b) Each of them is of a little thickness, the lower anatomy of the premaxilla, which would be impossible to do with only one wire of 3 mm diameter in a so small space due to the resistance of the wire when being bended.

c) The double disposition in a vertical way occupies a minimum space in the front close (10), preventing the grass accumulation.

d) If a retainer is cut, the prosthesis continues working without problems.

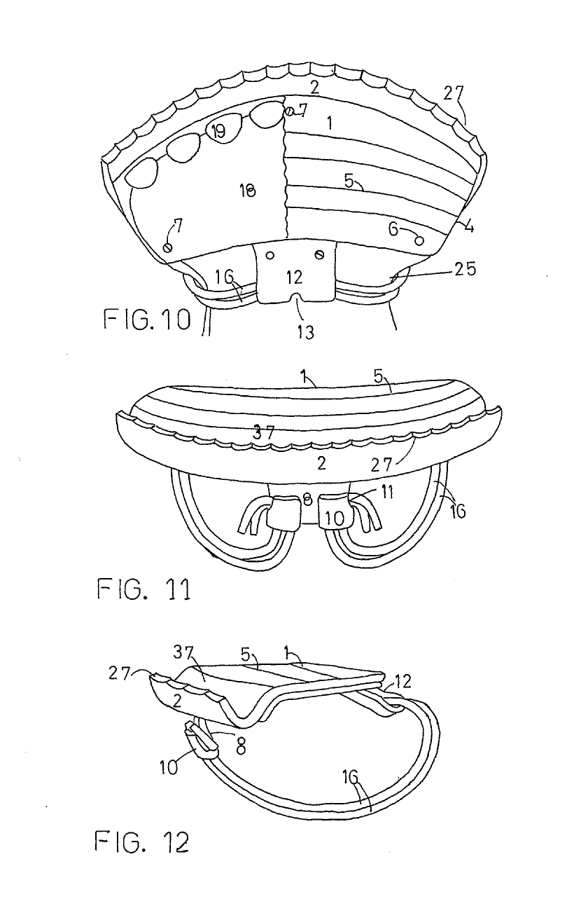

In FIG. 10, how the prosthesis protects the teeth (19) and the soft tissues of the premaxilla (18) in the transparent split zone can be appreciated.

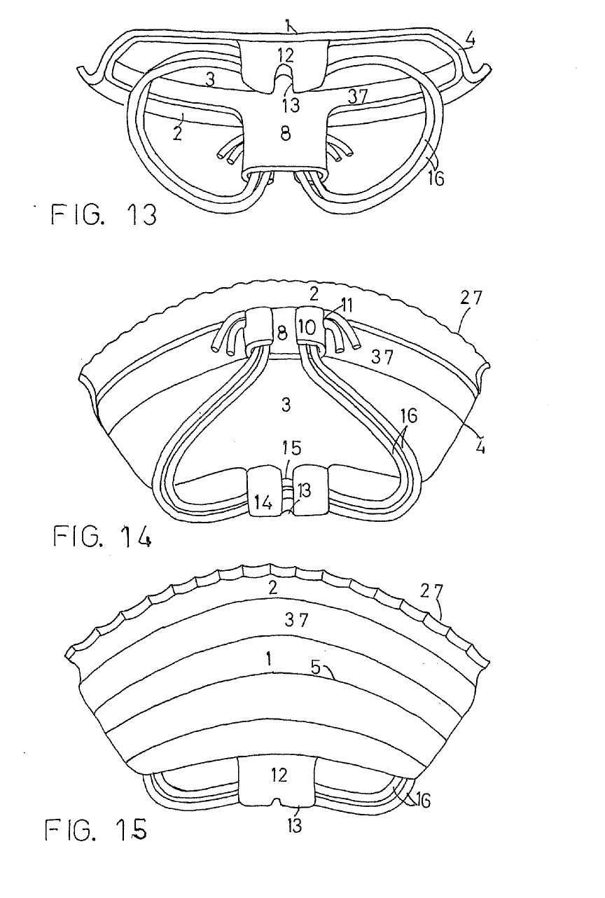

In FIGS. 11, 12, 13, 14 and 15 the standard dental prosthesis for bovines with fully worn down teeth from different positions is shown, being different from the prosthesis for bovines with partially worn down teeth in the fact that in the front curvature both laminar plates are slightly projected downwards (37) before making the front upward fold (2).

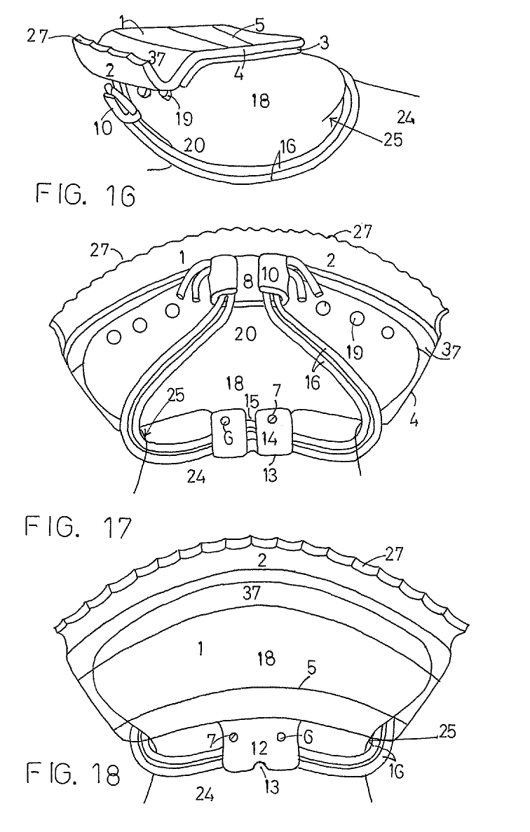

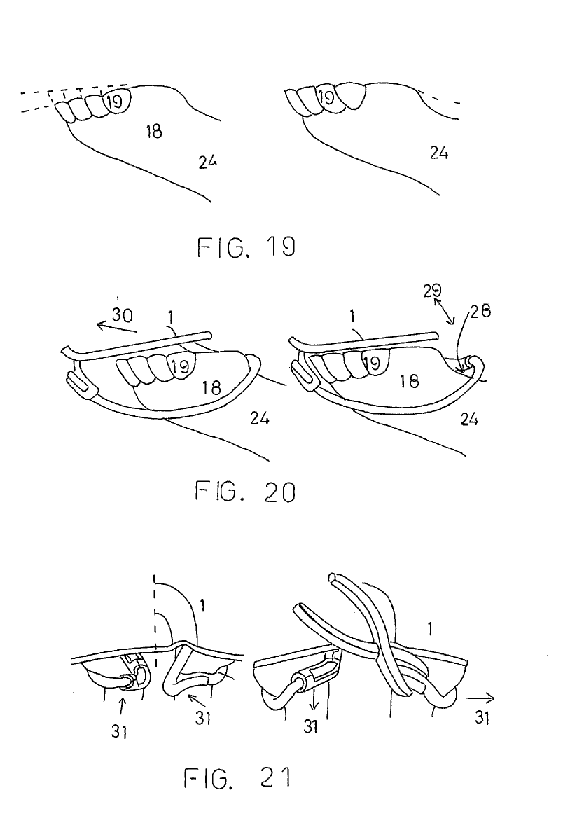

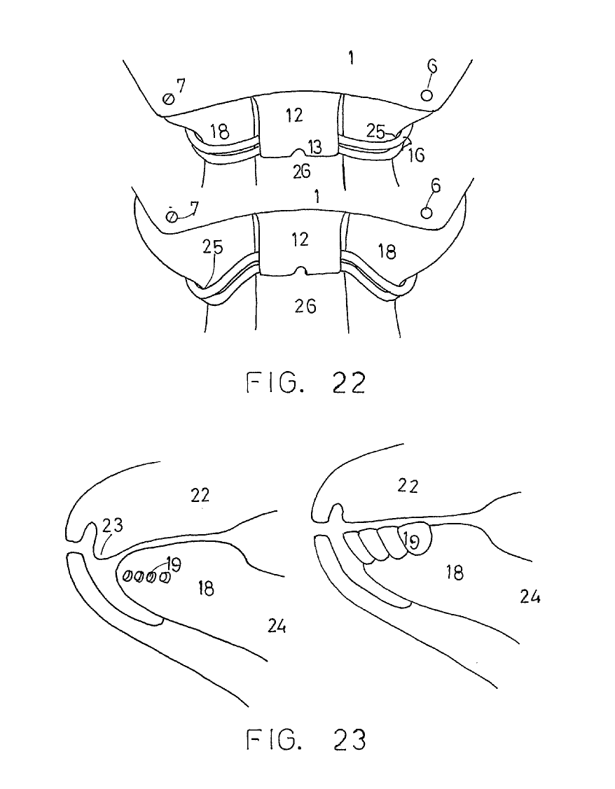

In FIGS. 16, 17 and 18 the same prosthesis is shown, mounted over a premaxilla of a fully toothless bovine animal where the different elements previously described are appreciated, the front close (10), the retainers (16), the upper laminar plate (1) and the lower laminar plate (3).

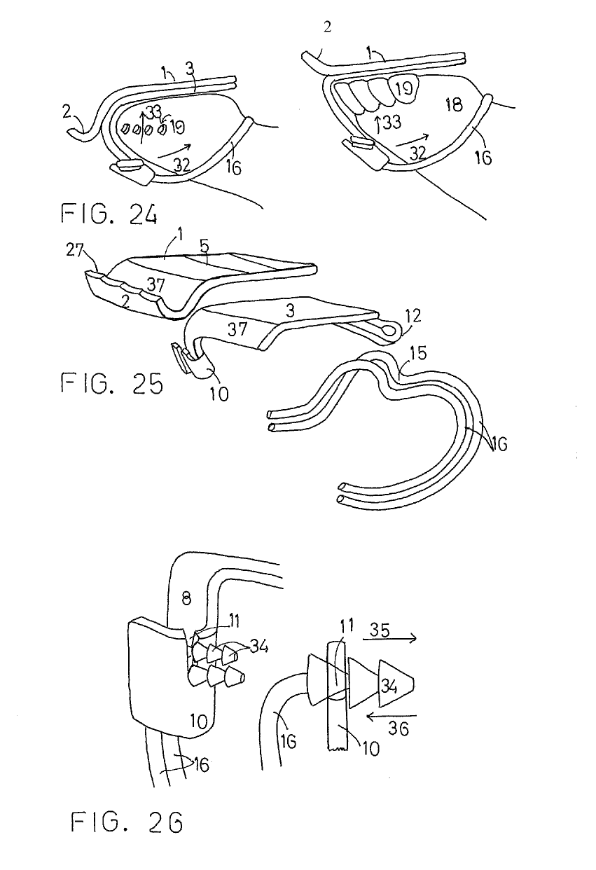

FIG. 23 shows at the right side, how both upper (22) and lower (18) jaws put into contact, when the natural teeth (10) have little wearing down and the upper jaw seats over the teeth in a flat way, that's why a flat laminar plate (1) is used in these cases, right FIG. 24 and to the left it is shown how both jaws (22) and (19) put into contact, when the front incisors (19) have been fully worn down, where in order to compensate the lack of incisors, the soft tissues of the front zone of the upper jaw (23) have been projected downwards, that's why the prosthesis being placed in these cases should present a downward curvature in the front zone (37) in FIG. 24.

FIG. 25 shows the prosthesis disassembling into three main elements thereof, the upper laminar plate (1), the lower laminar plate (3) and the wire retainers (16).

FIG. 26 shows the retainers made of carbon fibers, whose ends at the front close zone (8) have the form of successive cones (34) that block the pocket (11) of the plate (10) in the sense of (35) and the base of the cone by being bigger than the pocket (11) cannot return in the sense (36), being the retainer adjusted as those of wire.
(1) upper laminar plate
(2) upward folds
(3) lower laminar
(4) plate side
(5) nonslip surface
(6) drillings, screws
(7) ring staples, screws
(8) front tongue of the lower plate
(9) free ends of the front close
(10) close tongues
(11) pockets
(12) retainers support
(13) division of rear tongues
(14) fold retainers support
(15) retention curve
(16) retainers
(17) retainers folds
(18) lower premaxilla
(19) natural incisors
(20) mentalis zone of the premaxilla
(21) wing bone of the premaxilla
(22) upper jaw
(23) front deformed upper jaw
(24) lower jaw
(25) rear waist of lower premaxilla
(26) lingual channel
(27) sawn edge
(28) space between arm and waist of the premaxilla
(29) movement FIG. 20
(30) movement FIG. 20
(31) movement FIG. 21
(32) movement FIG. 24
(33) movement FIG. 24
(34) close cones
(35) adjustment sense FIG. 26
(36) block sense FIG. 26
(37) front curved folds

1. A standard dental prosthesis for bovine animals with partially worn down teeth characterized by being a laminar plate curved forwards of horizontal disposition made of rigid, stainless material, with slightly convergent sides behind, with a nonslip upper surface, with an upward and forward fold in the entire front curvature that presents a sawn edge, fixed through screws, ring staples or welding over another laminar plate of equal disposition and shape, where a tongue in the front central zone thereof is projected downwards with backward inclination from which end a smaller tongue appears at each side; these smaller tongues fold themselves through a fold in the front face being faced one another by the free ends thereof, appearing a pocket in the upper part of the fold, and from the rear-central part of the same laminar plate a tongue is projected backwards bending downwards in which end it divides into two folding over itself forwards, where they are fixed through screws, ring staples or welding, with two stainless wires pressed in the interior thereof by the middle zone in the transverse direction, getting out each pair by each side where it is projected forwards by each side going straight behind each tongue in the front zone and going out towards each side by the respective pockets of the laminates describing a fold downwards that is used to fix them in the place, being formed by this group an interior cavity capable of housing a premaxilla of bovine animal with partially worn down teeth.

2. A standard dental prosthesis for bovine animals with fully worn down teeth according to claim 1 characterized by the upper plate presenting a fold bending downwards and then an upward fold in the entire front curvature and the lower plate where it is mounted presents the same downward fold which centre is projected to the central tongue.

3. A standard dental prosthesis for bovine animals with partially or fully worn down teeth according to claim 1 characterized by when it is used with flexible retainers containing reinforcement fibers, presents a peripheral body in the front zone in the form of successive cones, one after the other so that they can hold back when entering into the pockets of the close front tongues.

4. A standard dental prosthesis for bovine animals with partially or fully worn down teeth according to claim 2 characterized by when it is used with flexible retainers containing reinforcement fibers, presents a peripheral body in the front zone in the form of successive cones, one after the other so that they can hold back when entering into the pockets of the close front tongues.
